(19) United States
(12) Patent Application Publication
(10) Pub. No.: US 2024/0291390 A1
(43) Pub. Date: Aug. 29, 2024

(54) CONTROL APPARATUS FOR THREE-TERMINAL STATIC DC TRANSFORMER

(71) Applicant: IKS Co., Ltd., Kyoto-shi, Kyoto (JP)

(72) Inventors: Yuichi KADO, Kyoto-shi, Kyoto (JP); Takashi IMAI, Kyoto-shi, Kyoto (JP); Takao GOTO, Kyoto-shi, Kyoto (JP)

(21) Appl. No.: 18/572,720

(22) PCT Filed: Jun. 15, 2022
(86) PCT No.: PCT/JP2022/023941

§ 371 Date: Dec. 20, 2023

(30) Foreign Application Priority Data
Jun. 23, 2021 (JP) 2021-104379

(51) Int. Cl. H02M 3/335; H02J 3/36

(52) U.S. Cl. CPC H02M 3/33576; H02J 3/36

(57) ABSTRACT

With a control apparatus for a three-terminal static DC transformer for drive-controlling the three-terminal static DC transformer, a computing unit is provided with first, second, and third self-excited single-phase inverters so that each of voltages at their AC sides is caused to become a rectangular wave of three levels which are a positive voltage, a null voltage, and a negative voltage, wherein the rectangular wave is caused to undergo time changes so that the rectangular wave of the positive voltage is repeated in a half-cycle by being folded at the null voltage; and the computing unit drives each of the first, second, and third self-excited single-phase inverters so that a product of a length of a section in which the AC-side voltage of each of the first, second, and third self-excited single-phase inverters is not zero, and a voltage between the first, second, and third DC terminals becomes equal.

### TECHNICAL FIELD

The present invention relates to a control apparatus for a three-terminal static DC transformer and is particularly suited for application to a control apparatus for drive-controlling a three-terminal static DC transformer with a large electric potential difference between respective DC terminals.

### BACKGROUND ART

In recent years, there has been a worldwide tendency of increased use of renewable energy represented by solar power generation energy as a global warming countermeasure. Along with this, there has been an increasing demand for storage batteries for storing electricity of the generated renewable energy. Also, the development and use of fuel cells which generate electricity from natural gas are being promoted.

Additionally, in Europe, they are trying to advance the spread of electric cars on a national level by prohibiting the sale of gasoline cars from the viewpoint of the global warming prevention; and accordingly, cost reduction and performance improvement through mass production of rechargeable/dischargeable storage batteries to be mounted in the electric cars are underway.

Since the solar power generation apparatuses, storage batteries, fuel cells, etc. generate or store electric power as direct currents, the electric power which is output from them is converted into alternating currents by inverters and then used.

However, along with a boost with the spread of LED lights and DC home electric appliances in recent years, the spread of DC distribution networks without any AC-DC conversion loss is expected. This is attributable to low prices and enhanced reliability of the inverters because of the development of self-arc-extinguishing semiconductor elements which are represented by IGBT (Insulated Gate Bipolar Transistors) and power MOSFET (Metal-Oxide-Semiconductor Field-Effect Transistors) and research and development of the DC distribution networks as next generation distribution networks are underway.

When connecting different voltages in a DC distribution network, a two-terminal-type static transformer is used, which converts a direct current into a high-frequency alternating current, causes the voltage to rise or fall via an AC transformer of an appropriate winding ratio, and then converts it to the direct current again. Also, when DC distribution networks of various shapes are to be configured, a static DC transformer with three terminals, but not two terminals, which implements respective connection adjustments is required.

Incidentally, PTL 1 mentioned below discloses, as an invention relating to a three static DC transformer, a control apparatus for drive-controlling a static DC transformer to which three or more self-excited single-phase inverters, each of which is parallelly connected to a DC capacitor, are connected via a high frequency transformer, wherein in a state where a DC voltage is applied to one DC terminal and the DC terminal is maintained at a constant voltage, the control apparatus is provided with: a detector that detects each of voltages of the respective DC terminals; a minimum voltage terminal selection circuit that selects a DC terminal with the lowest voltage among the DC terminals to which the DC voltage is not applied, based on the detection result of the detector; and an arithmetic circuit that causes the self-excited single-phase inverter, to which the DC voltage is applied, to generate an AC voltage of a size proportional to the difference between the voltage of the DC terminal to which the DC voltage is applied, and the voltage of the DC terminal selected by the minimum voltage terminal selection circuit.

### CITATION LIST

### Patent Literature

PTL 1: Japanese Patent Application Laid-Open (Kokai) Publication No. 2019-41436

### SUMMARY OF THE INVENTION

### Problems to be Solved by the Invention

Meanwhile, there are various operating voltages and output voltages of loading apparatuses for, for example, DC home electric appliances, charge/discharge equipment for the electric cars, storage batteries, and solar cells which are connected to DC distribution networks. For example, if a bus line voltage of a DC distribution network is 380V to 400V, a voltage range is widely distributed as follows: a voltage of a storage battery for an electric car connected to this DC distribution network is 200V to 400V, a voltage of LED light equipment is 100V, and a voltage of DC home electric appliances is 48V.

When a loading apparatus, a storage battery, and a bus line whose operating voltages and output voltages vary considerably as described above are connected by a static DC transformer, a large voltage difference occurs between DC terminals of the static DC transformer. As a result, the following problems occur: a current peak value and an effective current value which flow through circuit elements on an AC side of the static DC transformer become large, thereby impairing safety; and an electric current value of a circulating current which circulates across the AC side and does not contribute to transmission of the electric power becomes large, thereby causing degradation of conversion efficiency.

The present invention was devised in consideration of the above circumstances and aims at proposing a control apparatus for a three-terminal static DC transformer, which is capable of effectively preventing the safety impairment and the degradation of the conversion efficiency even when the voltage difference between the DC terminals is large.

### Means to Solve the Problems

In order to solve the above-described problems, there is provided according to the present invention a control apparatus for a three-terminal static DC transformer for drive-controlling the three-terminal static DC transformer configured so that first, second, and third self-excited single-phase inverters which are connected parallelly to DC capacitors, respectively, at their DC sides are connected via a high frequency transformer at their AC sides so as to supply electric power between first, second, and third DC terminals to which the first, second, and third self-excited single-phase inverters corresponding to the first, second, and third DC terminals, respectively, are connected, the control apparatus comprising a computing unit that: causes each of voltages at the AC sides to become a rectangular wave of three levels which are a positive voltage, a null voltage, and a negative voltage, wherein the rectangular wave undergoes time changes so that the rectangular wave of the positive voltage is repeated in a half-cycle by being folded at the null voltage; and drives each of the first, second, and third self-excited single-phase inverters so that a product of a length of a section in which the AC-side voltage of each of the first, second, and third self-excited single-phase inverters is not zero, and a voltage between the first, second, and third DC terminals becomes equal.

If the control apparatus for the three-terminal static DC transformer according to the present invention is employed, it is possible to suppress a peak value and a root mean square value of an electric current at the AC sides of the first to third self-excited single-phase inverters and minimize a circulating current which circulates between these AC sides and does not contribute to the transmission of the electric power.

### Advantageous Effects of the Invention

Even when the voltage difference between the DC terminals is large, the control apparatus for the three-terminal static DC transformer, which is capable of effectively preventing the safety impairment and the degradation of the conversion efficiency can be implemented according to the present invention.

### BRIEF DESCRIPTION OF DRAWINGS

FIG. 1 is a circuit diagram illustrating a configuration example of a three-terminal static DC transformer.

FIG. 2 is a block diagram illustrating a partial configuration of a control apparatus for drive-controlling the three-terminal static DC transformer in FIG. 1.

FIG. 3 is a circuit diagram illustrating a circuit configuration of first to third self-excited single-phase inverter circuits.

FIG. 4(A) is a waveform chart indicating a waveform example of conventional first and third ignition pulses; FIG. 4(B) is a waveform chart indicating a waveform example of conventional second and fourth ignition pulses; and FIG. 4(C) is a waveform chart indicating a waveform example of AC-side voltages of the first to third self-excited single-phase inverter circuits according to a conventional control system.

FIG. 5(A) is a waveform chart indicating a waveform example of first and third ignition pulses according to a control system of this embodiment; FIG. 5(B) is a waveform chart indicating a waveform example of second and fourth ignition pulses according to the control system of this embodiment; FIG. 5(C) is a waveform chart indicating a waveform example of AC-side voltages of first to third self-excited single-phase inverter circuits according to the control system of this embodiment; and FIG. 5(D) is a waveform chart indicating a waveform obtained by folding a negative side of the AC-side voltages of the first to third self-excited single-phase inverter circuits according to the control system of this embodiment towards a positive side at a null voltage.

FIG. 6(A) is a waveform chart obtained by extracting a voltage waveform of one cycle of the AC-side voltages of the first to third self-excited single-phase inverter circuits according to the control system of this embodiment; and FIG. 6(B) is a waveform chart obtained by folding the negative side of the waveform of (A) towards the positive side at a null voltage.

FIG. 7 is a waveform chart indicating temporal changes of the AC-side voltages of the first to third self-excited single-phase inverter circuits according to the control system of this embodiment.

FIG. 8(A) is a waveform chart indicating time changes of the AC-side voltages of the first to third self-excited single-phase inverter circuits according to a conventional system; and FIG. 8(B) is a waveform chart indicating time changes of AC-side currents of the first to third self-excited single-phase inverter circuits at that time.

FIG. 9(A) is a waveform chart indicating time changes of the AC-side voltages of the first to third self-excited single-phase inverter circuits according to the control system of this embodiment; and FIG. 9(B) is a waveform chart indicating time changes of the AC-side currents of the first to third self-excited single-phase inverter circuits at that time.

### DESCRIPTION OF EMBODIMENTS

An embodiment of the present invention will be described below in detail with reference to the drawings.

### (1) Configuration of Three-Terminal Static DC Transformer According to this Embodiment

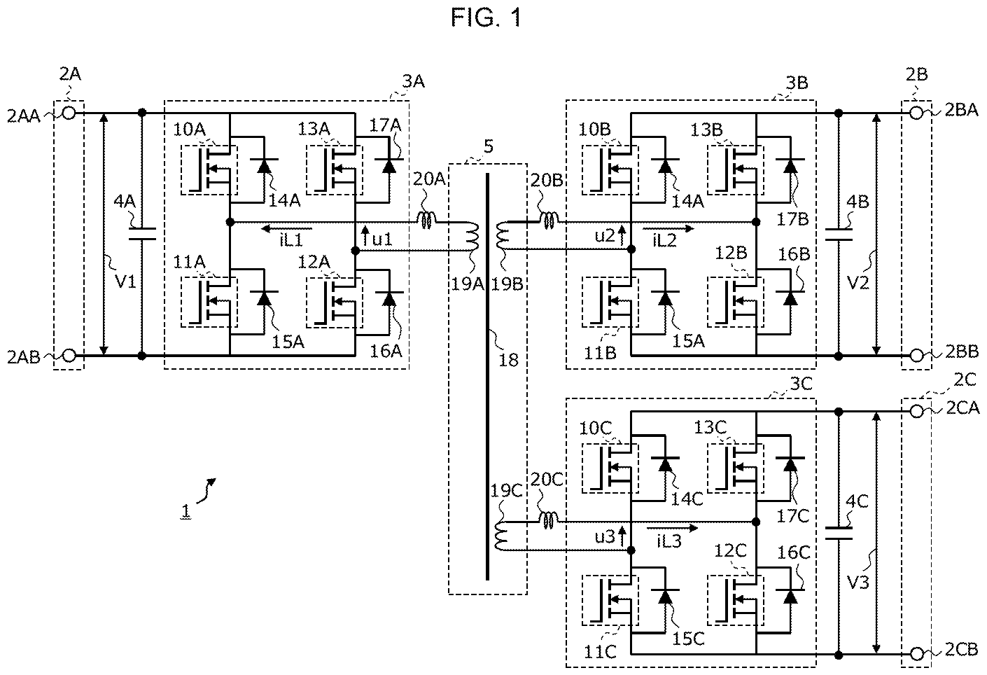

Referring to FIG. 1, the reference numeral 1 represents a three-terminal static DC transformer according to this embodiment as a whole. This three-terminal static DC transformer 1 is configured by including: a first self-excited single-phase inverter circuit 3A and a first DC capacitor 4A which are connected parallelly between first and second terminals 2AA, 2AB which constitute a first DC port terminal 2A; a second self-excited single-phase inverter circuit 3B and a second DC capacitor 4B which are connected parallelly between first and second terminals 2BA, 2BB which constitute a second DC port terminal 2B; a third self-excited single-phase inverter circuit 3C and a third DC capacitor 4C which are connected parallelly between first and second terminals 2CA, 2CB which constitute a third DC port terminal 2C; and a three-winding high-frequency transformer 5 that connects the first to third self-excited single-phase inverter circuits 3A to 3C together.

The first self-excited single-phase inverter circuit 3A is configured so that first to fourth self-arc-extinguishing elements 10A, 11A, 12A, 13A are connected in a bridge form and first to fourth diodes 14A, 15A, 16A, 17A are connected parallelly to these first to fourth self-arc-extinguishing elements 10A to 13A, respectively.

Then, regarding the first self-excited single-phase inverter circuit 3A, a connection midpoint of the first and fourth self-arc-extinguishing elements 10A, 13A is connected to a first terminal 2AA of the first DC port terminal 2A and a connection midpoint of the second and third self-arc-extinguishing elements 11A, 12A is connected to a second terminal 2AB of the first DC-side port terminal 2A.

Similarly, the second self-excited single-phase inverter circuit 3B is configured so that first to fourth self-arc-extinguishing elements 10B, 11B, 12B, 13B are connected in a bridge form and first to fourth diodes 14B, 15B, 16B, 17B are connected parallelly to these first to fourth self-arc-extinguishing elements 10B to 13B, respectively.

Then, regarding the second self-excited single-phase inverter circuit 3B, a connection midpoint of the first and fourth self-arc-extinguishing elements 10B, 13B is connected to a first terminal 2BA of the second DC port terminal 2B and a connection midpoint of the second and third self-arc-extinguishing elements 11B, 12B is connected to a second terminal 2BB of the second DC-side port terminal 2B.

Moreover, the third self-excited single-phase inverter circuit 3C is configured from a bridge circuit so that first to fourth self-arc-extinguishing elements 10C, 11C, 12C, 13C are connected in a bridge form and first to fourth diodes 14C, 15C, 16C, 17C are connected parallelly to these first to fourth self-arc-extinguishing elements 10C to 13C.

Then, regarding the third self-excited single-phase inverter circuit 3C, a connection midpoint of the first and fourth self-arc-extinguishing elements 10C, 13C is connected to a first terminal 2CA of the third DC port terminal 2C and a connection midpoint of the second and third self-arc-extinguishing elements 11C, 12C is connected to a second terminal 2CB of the third DC-side port terminal 2C.

The three-winding high-frequency transformer 5 is configured by including first to third windings 19A, 19B, 19C which are wound around an iron core 18. Then, regarding the first winding 19A, its one end side is connected via a first external inductor 20A to the connection midpoint of the first and second self-arc-extinguishing elements 10A, 11A of the first self-excited single-phase inverter circuit 3A and the other end side is connected to the connection midpoint of the third and fourth self-arc-extinguishing elements 12A, 13A.

Moreover, regarding the second winding 19B, its one end side is connected via a second external inductor 20B to the connection midpoint of the first and second self-arc-extinguishing elements 10B, 11B of the second self-excited single-phase inverter circuit 3B and the other end side is connected to the connection midpoint of the third and fourth self-arc-extinguishing elements 12B, 13B.

Furthermore, regarding the third winding 19C, its one end side is connected via a third external inductor 20C to the connection midpoint of the first and second self-arc-extinguishing elements 10C, 11C of the third self-excited single-phase inverter circuit 3C and the other end side is connected to the connection midpoint of the third and fourth self-arc-extinguishing elements 12C, 13C.

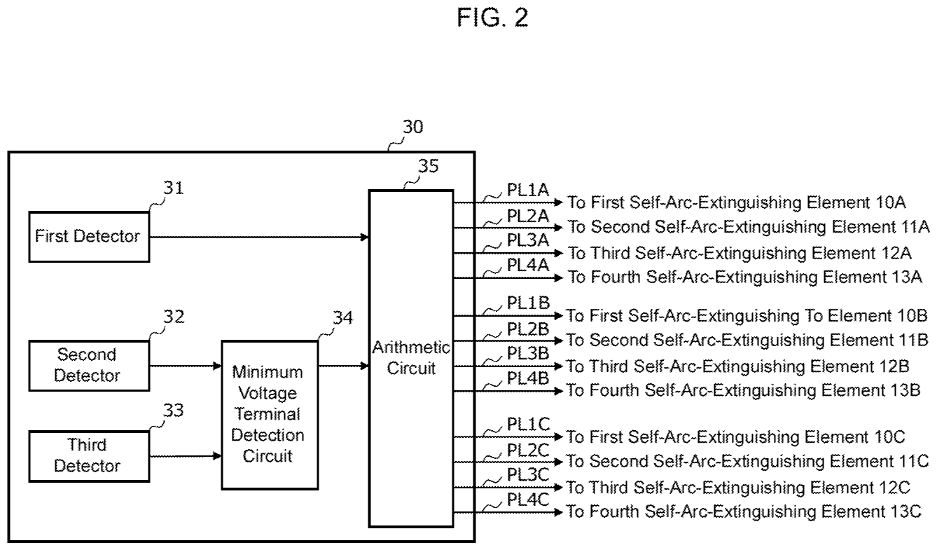

FIG. 2 illustrates the configuration of a control apparatus 30 according to this embodiment for controlling operations of the first to third self-excited single-phase inverter circuits 3A to 3C for the three-terminal static DC transformer 1. This control apparatus 30 is configured by including first to third detectors 31 to 33, a minimum voltage terminal detection circuit 34, and an arithmetic circuit 35.

The first detector 31 is a voltage detector for detecting an electric potential difference between the first and second terminals 2AA, 2AB of the first DC-side port terminal 2A as a first DC-side port voltage V1 (FIG. 1) and outputs the detected value of the first DC-side port voltage V1 to the arithmetic circuit 35.

Moreover, the second detector 32 is a voltage detector for detecting an electric potential difference between the first and second terminals 2BA, 2BB of the second DC-side port terminal 2B as a second DC-side port voltage V2 (FIG. 1) and outputs the detected value of the second DC-side port voltage V2 to the minimum voltage terminal detection circuit 34.

The third detector 33 is a voltage detector for detecting an electric potential difference between the first and second terminals 2CA, 2CB of the third DC-side port terminal 2C as a third DC-side port voltage V3 (FIG. 1) and outputs the detected value of the third DC-side port voltage V3 to the minimum voltage terminal detection circuit 34.

The minimum voltage terminal detection circuit 34 selects either the value of the second DC-side port voltage V2 given from the second detector 32 or the value of the third DC-side port voltage V3 given from the third detector 33, whichever is lower, and notifies the arithmetic circuit 35 of the selected value of the second or third DC-side port voltage V2, V3.

The arithmetic circuit 35 generates, based on the value of the first DC-side port voltage V1 given from the first detector 31 and the value of the second or third DC-side port voltage V2, V3 given from the minimum voltage terminal detection circuit 34, first to fourth ignition pulses PL1A, PL2A, PL3A, PL4A which should be applied respectively to the first to fourth self-arc-extinguishing elements 10A to 13A of the first self-excited single-phase inverter circuit 3A, first to fourth ignition pulses PL1B, PL2B, PL3B, PL4B which should be applied respectively to the first to fourth self-arc-extinguishing elements 10B to 13B of the second self-excited single-phase inverter circuit 3B, and first to fourth ignition pulses PL1C, PL2C, PL3C, PL4C which should be respectively applied to the first to fourth self-arc-extinguishing elements 10C to 13C of the third self-excited single-phase inverter circuit 3C, respectively.

Then, the arithmetic circuit 35 applies these generated first to fourth ignition pulses PL1A to PL4A, PL1B to PL4B, PL1C to PL4C to the first to fourth self-arc-extinguishing elements 10A to 13A, 10B to 13B, 10C to 13C of their respectively corresponding first to third self-excited single-phase inverter circuits 3A to 3C.

Consequently, the first to fourth self-arc-extinguishing elements 10A to 13A, 10B to 13B, 10C to 13C of the first to third self-excited single-phase inverter circuits 3A to 3C respectively execute a switching operation based on these first to fourth ignition pulses PL1A to PL4A, PL1B to PL4B, PL1C to PL4C; and as a result, the electric power is transmitted between the first to third self-excited single-phase inverter circuits 3A to 3C.

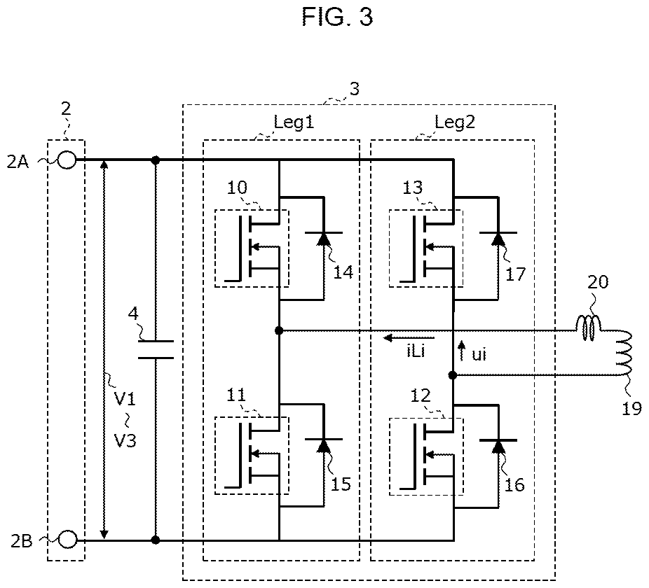

Incidentally, in the following explanation, if it is unnecessary to distinguish between the first to third self-excited single-phase inverter circuits 3A to 3C, the reference numeral of each constituent element may be sometimes expressed with just the number without the additional character “A” to “C” as shown in FIG. 3. However, the first terminals 2AA to 2CA of the first to third DC port terminals 2A to 2C may be expressed as the first terminal 2A and the second terminals 2AB to 2CB may be sometimes expressed as the second terminal 2B.

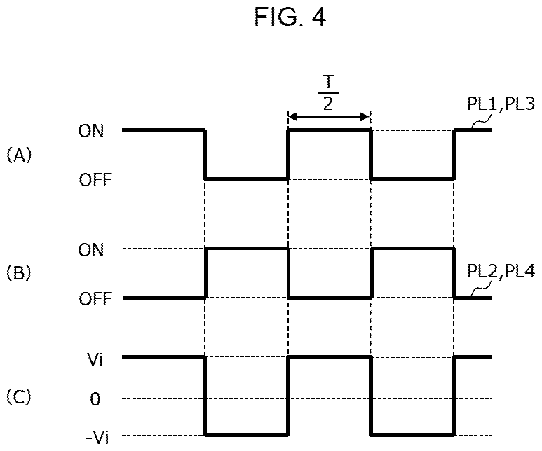

Moreover, if it is unnecessary to distinguish between the first to third self-excited single-phase inverter circuits 3A to 3C, the first ignition pulses PL1A to PL1C to be applied to the first self-arc-extinguishing element 10 may be sometimes expressed as PL1, the second ignition pulses PL2A to PL2C to be applied to the second self-arc-extinguishing element 11 may be sometimes expressed as PL2, the second ignition pulses PL3A to PL3C to be applied to the third self-arc-extinguishing element 12 may be sometimes expressed as PL3, and the second ignition pulses PL4A to PL4C to be applied to the fourth self-arc-extinguishing element 13 may be sometimes expressed as PL4 as shown in FIG. 4(A) and (B).

### (2) Control System for Three-Terminal Static DC Transformer According to this Embodiment

Here, with the first to third self-excited single-phase inverter circuits 3 as shown in FIG. 3, a pair of the first and second self-arc-extinguishing elements 10, 11 will be referred to as a first self-arc-extinguishing element pair Leg1 and a pair of the third and fourth self-arc-extinguishing elements 12, 13 will be referred to as a second self-arc-extinguishing element pair Leg2.

Normally, the first ignition pulse PL1 to be applied to the first self-arc-extinguishing element 10 and the third ignition pulse PL3 to be applied to the third self-arc-extinguishing element 12 are rectangular waves of the same phase whose duty ratio is 50%, and the second ignition pulse PL2 to be applied to the second self-arc-extinguishing element 11 and the fourth ignition pulse PL4 to be applied to the fourth self-arc-extinguishing element 13 are rectangular waves of the same phase whose duty ratio is 50% and which are obtained by reversing the ignition pulses PL1, PL3 to be applied to the first and third self-arc-extinguishing elements 10, 12 as illustrated in FIG. 4(B).

Under this circumstances, time changes of a voltage(s) ui (i=1, 2, 3) (see FIG. 1) at the AC sides of the first to third self-excited single-phase inverter circuits 3 result in the rectangular waves whose duty ratio is 50% and whose amplitude is between a positive voltage (Vi (i=1, 2, 3)) (see FIG. 1) and a negative voltage (−Vi) as illustrated in FIG. 4(C). Incidentally, u1, u2, and u3 are the voltages at the AC sides of the first, second, and third self-excited single-phase inverter circuits 3A to 3C, respectively.

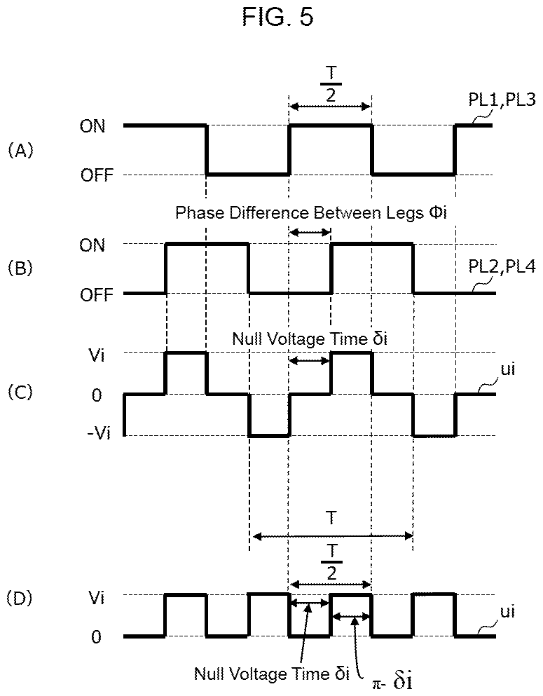

On the other hand, this embodiment is characterized in that the arithmetic circuit 35 (FIG. 2) applies the first to fourth ignition pulses PL1 to PL4, which have the phase difference ϕi (i=1, 2, 3) between the first and second self-arc-extinguishing element pairs Leg1, Leg2 as illustrated in FIG. 5(A) and FIG. 5(B), to the first to fourth self-arc-extinguishing elements 10 to 13, respectively, with respect to the first to third self-excited single-phase inverter circuits 3. Incidentally, each of ϕ1, ϕ2, and ϕ3 represents the phase difference between the first and second self-arc-extinguishing element pairs Leg1, Leg2 respectively at the first, second and third self-excited single-phase inverter circuits 3A to 3C.

Specifically speaking, the arithmetic circuit 35 applies, with respect to the first to third self-excited single-phase inverter circuits 3, the third ignition pulse PL3 which has the phase difference Di from the first ignition pulse PL1 to be applied to the first self-arc-extinguishing element 10 is applied to the third self-arc-extinguishing element 12 and the fourth ignition pulse PL4 which has the phase difference Di from the second ignition pulse PL2 to be applied to the second self-arc-extinguishing element 11 that is an opposite phase of the first ignition pulse PL1 (that is, an opposite phase of the third ignition pulse PL3) is applied to the fourth self-arc-extinguishing element 13.

As a result, the time changes of the voltage ui at the AC sides of the first to third self-excited single-phase inverter circuits 3 result in a three-level voltage operation of a positive voltage (Vi), a null voltage, and a negative voltage (−Vi) as illustrated in FIG. 5(C). If the duty ratio of the first to fourth ignition pulses PL1 to PL4 is 50%, the time when the voltage ui at the AC side is the positive voltage (V) is equal to the time when the voltage ui at the AC side is the negative voltage (−Vi) and a section where the voltage ui at the AC side becomes the null voltage (hereinafter referred to as a “null voltage section”) δi (i=1, 2, 3) is a variable section which can be controlled by the phase difference ϕi (i=1, 2, 3) between the first and second self-arc-extinguishing element pairs Leg1, Leg2 for the first to third self-excited single-phase inverter circuits 3. Incidentally, δ1, δ2, and δ3 are the aforementioned null voltage sections of the first, second and third self-excited single-phase inverter circuits 3A to 3C, respectively.

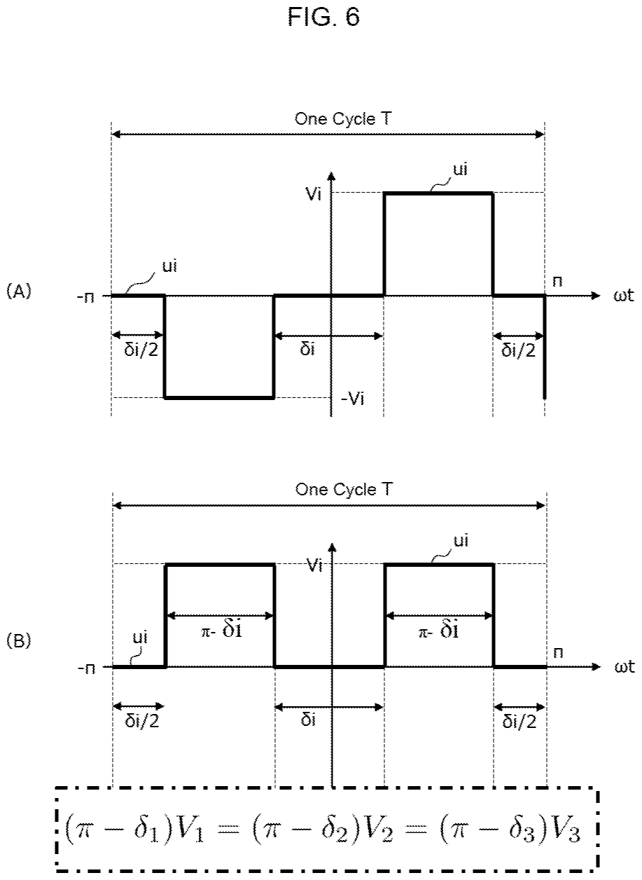

FIG. 6(A) illustrates an extracted voltage waveform for one cycle of the voltage ui at the AC sides of the first to third self-excited single-phase inverter circuits 3 and FIG. 6(B) illustrates a voltage waveform obtained by folding the negative side of this voltage waveform towards the positive side at the null voltage (the same applies to FIG. 5(D)). The null voltage section δi of the cyclic voltage waveform illustrated in this FIG. 6(A) is equal to the phase difference ϕi between the first and second self-arc-extinguishing element pairs Leg1, Leg2 as is apparent from FIG. 5(A) to FIG. 5(C). Therefore, the section width of the null voltage section oi can be controlled as the phase difference di between the first and second self-arc-extinguishing element pairs Leg1, Leg2.

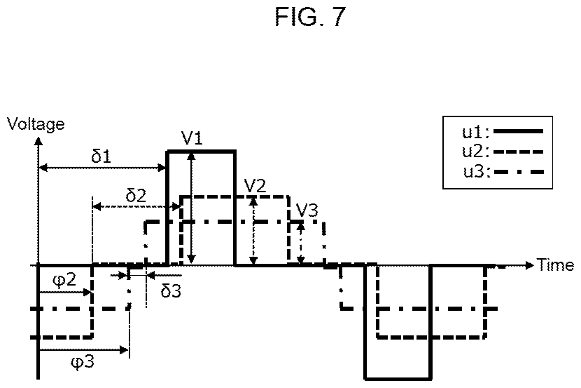

Moreover, when the values of the first to third DC-side port voltages V1 to V3 are determined with the three-terminal static DC transformer 1 according to this embodiment illustrated in FIG. 1, the direction and size of the electric power transmission between the respective first to third DC-side port terminals 2A to 2C can be controlled by the phase difference φi (i=2, 3) (see FIG. 7) of the first to fourth ignition pulses PL1B to PL4B, PL1C to PL4C to be applied to the first to fourth self-arc-extinguishing elements 10B to 13B, 10C to 13C for the second and third self-excited single-phase inverter circuits 3B, 3C relative to the first to fourth ignition pulses PL1A to PL4A to be applied respectively to the first to fourth self-arc-extinguishing elements 10A to 13A for the first self-excited single-phase inverter circuit 3A.

So, in the case of this embodiment, the arithmetic circuit 35 (FIG. 2) for the control apparatus 30 (FIG. 2) determines the null voltage section oi of the voltage ui at the AC sides of the first to third self-excited single-phase inverter circuits 3A to 3C so as to satisfy the following conditional expression. Under this circumstance, V1 to V3 represent DC-side port voltages.

### [Math. 1]

$$( π - δ 1 ) V 1 = ( π - δ 2 ) V 2 = ( π - δ 3 ) V 3 \qquad ( 1 )$$

The phases of the ignition pulses between the first and second self-arc-extinguishing element pairs Leg1, Leg2 (the first and third ignition pulses PL1, PL3 and the second and fourth ignition pulses PL2, PL4) in the first to third self-excited single-phase inverter circuits 3A to 3C are controlled so as to satisfy the above-mentioned expression. By doing so, it is possible to reduce a peak value and a root mean square value of the alternating current and minimize the circulating electric power which does not contribute to the electric power transmission. The reason for this will be explained below.

FIG. 7 illustrates temporal changes of the voltages u1 to u3 at the AC sides of the first to third self-excited single-phase inverter circuits 3A to 3C when regarding the three-terminal static DC transformer 1 according to this embodiment, the null voltage sections δ1 to δ3 are set respectively by the phase differences ϕ1 to ϕ3 between the first and second self-arc-extinguishing element pairs Leg1, Leg2 for the first to third self-excited single-phase inverter circuits 3A to 3C.

Under this circumstance, it is assumed that the values of the first to third port voltages Vi (i=1, 2, 3) are different from each other and the electric power transmission is performed with respect to the first to fourth ignition pulses PL1A to PL4A to be applied respectively to the first to fourth self-arc-extinguishing elements 10A to 13A for the first self-excited single-phase inverter circuit 3A by giving the phase difference q2 to the first to fourth ignition pulses PL1B to PL4B to be applied respectively to the first to fourth self-arc-extinguishing elements 10B to 13B for the second self-excited single-phase inverter circuit 3B and giving the phase difference q3 to the first to fourth ignition pulses PL1C to PL4C to be applied respectively to the first to fourth self-arc-extinguishing elements 10C to 13C for the third self-excited single-phase inverter circuit 3C.

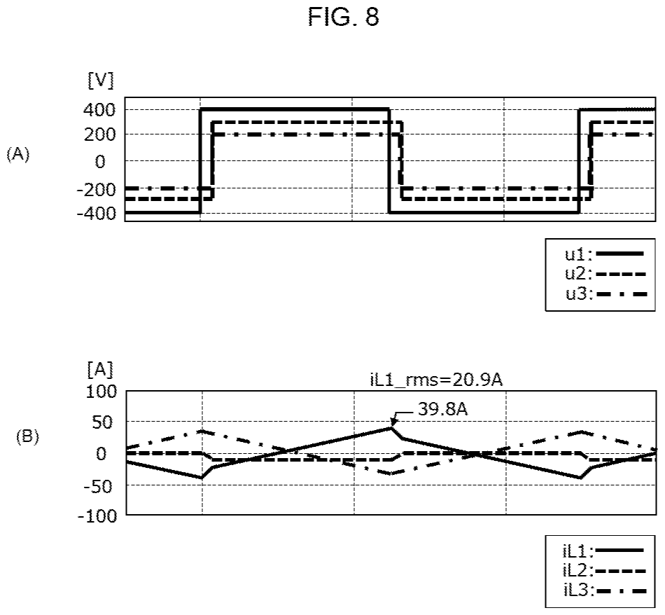

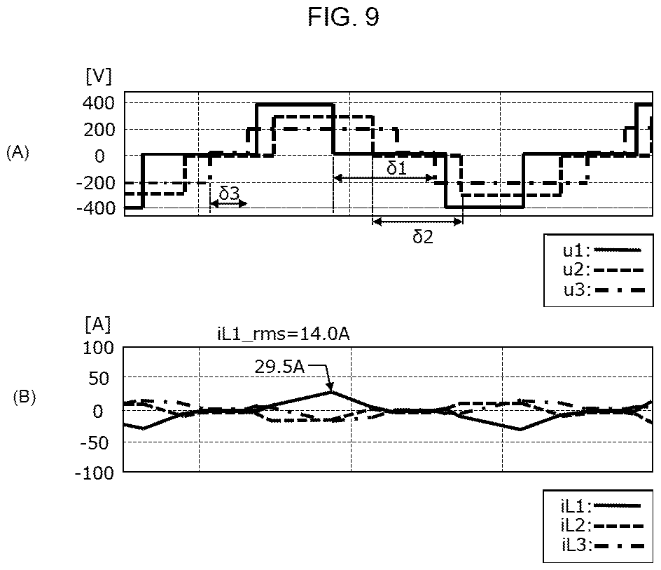

Incidentally, in FIG. 7, a straight-line waveform corresponds to the voltage u1 at the AC side of the first self-excited single-phase inverter circuit 3A; a broken-line waveform corresponds to the voltage u2 at the AC side of the second self-excited single-phase inverter circuit 3B; and a dash-dotted-line waveform corresponds to the voltage u3 at the AC side of the third self-excited single-phase inverter circuit 3C. The same applies to FIG. 8(A) and FIG. 8(B) and FIG. 9(A) and FIG. 9(B) described below.

When there is a voltage difference between the DC-side port voltages and if the three-terminal static DC transformer 1 is driven as in a conventional manner according an ignition pulse system without the phase difference between the first and second self-arc-extinguishing element pairs Leg1, Leg2, FIG. 8(A) illustrates temporal changes of the voltages u1 to u3 at the AC sides of the first to third self-excited single-phase inverter circuits 3A to 3C and FIG. 8(B) illustrates time changes of the electric currents iL1 to iL3 at the AC sides of the first to third self-excited single-phase inverter circuits 3A to 3C.

In FIG. 8(B), the voltage u1 at the AC side of the first self-excited single-phase inverter circuit 3A is 400V; the voltage u2 at the AC side of the second self-excited single-phase inverter circuit 3B is 300V; and the voltage u3 at the AC side of the third self-excited single-phase inverter circuit 3C is 200V. Under this circumstance, if attention is focused on the electric current iL1 at the AC side of the first self-excited single-phase inverter circuit 3A, its peak value is 39.8 A and its root mean square value is 20.9 A. If attention is focused on the voltage (u1) of the first self-excited single-phase inverter circuit and the inductor current iL1 at the AC side, the inductor current iL1 flows significantly towards the negative side upon switching (−400V->400V) and then starts to flow towards the positive side. As a result, positive and negative offset of the electric current is caused and the transmitted electric power amount within a cycle has reduced. Furthermore, the inductor current iL1 continues to increase after the switching and during a half-cycle, so that the peak value reaches 39.8 A.

As is apparent from these FIG. 8(A) and FIG. 8(B), the electric currents iL1 to iL3 at the AC sides of the first to third self-excited single-phase inverter circuits 3A to 3C switch from rising to falling or from falling to rising at a timing when their respectively corresponding voltages u1 to u3 switch from a positive voltage to a negative voltage or from the negative voltage to the positive voltage. Then, a temporal change amount of the electric currents iL1 to iL3 after switching from rising to falling or from falling to rising becomes larger when the electric potential difference before and after switching is larger and the switching cycle is longer.

Then, as illustrated in FIG. 9(A), a section oi where the voltage becomes a null voltage is added to the voltage ui of the self-excited single-phase inverter circuit which is conventionally formed of two levels. By using this method, the inductor currents (IL1 to iL3) become zero at every half-cycle, which suppresses the peak value. Also, by causing the reverse current at the time of switching (for example, −400V->400V) to become zero and causing the inductor current to become zero when the inductor voltage of the inverter circuit is zero, it is possible to reduce the circulating electric power which will result in a loss that does not contribute to the transmitted electric power.

When the three-level operation is employed by adopting the ignition pulse system that gives the phase differences ϕ1 to ϕ3 between the first and second self-arc-extinguishing element pairs Leg1, Leg2 as in this embodiment and the three-terminal static DC transformer 1 is driven to control the phase differences ϕ1 to ϕ3 so that the null voltage sections δ1 to δ3 satisfy the aforementioned Expression (1), FIG. 9(A) illustrates temporal changes of the voltages u1 to u3 at the AC sides of the first to third self-excited single-phase inverter circuits 3A to 3C and FIG. 9(B) illustrates time changes of the electric currents iL1 to iL3 at the AC sides of the first to third self-excited single-phase inverter circuits 3A to 3C. If as a condition for making this circulating power become zero the reverse current at the time of switching (for example, −400V→400V) is made zero and the inductor current is zero when the voltage of the inverter circuit is zero, this will suppress the electric current which circulates through only the switch and the inductor and which does not transmit the electric power. The conditional expression (1) is derived from this condition.

When the ignition pulse system of this embodiment is employed as illustrated in FIG. 9(B) and if attention is focused on the electric current iL1 at the AC side of the first self-excited single-phase inverter circuit 3A, its peak value is suppressed to 29.5 A and its root mean square value is suppressed to 14.0 A.

This is caused by the fact that, in the case of the three-level operation as in this embodiment, the voltages u1 to u3 at the AC sides of the first to third self-excited single-phase inverter circuits 3A to 3C switch from the positive voltage to the null voltage, then from the null voltage to the negative voltage, and further from the negative voltage to the null voltage at a speed twice as fast as the two-level operation, so that the electric potential difference before and after switching becomes a half of the electric potential difference for the two-level operation.

Accordingly, the voltages u1 to u3 at the AC sides of the first to third self-excited single-phase inverter circuits 3A to 3C switch in a cycle twice as long as that of the two-level operation and the electric potential difference before and after switching also becomes a half of that of the two-level operation, so that the temporal change amount of the electric currents iL1 to iL3 reduces and both the peak values and the root mean square values of the electric currents iL1 to iL3 at the AC sides are suppressed as compared to those for the two-level operation.

Moreover, when the three-level operation is employed as in this embodiment, the sections where all the voltages u1 to u3 at the AC sides of the first to third self-excited single-phase inverter circuits 3A to 3C become zero occur as is apparent from FIG. 7. Then, in these sections, no electric current flows or no circulating current occurs at any of the first to third windings 19A to 19C of the three-winding high-frequency transformer 5 (FIG. 1).

Therefore, when adopting the ignition pulse system of this embodiment, the circulating current which occurs at the three-winding high-frequency transformer 5 can be minimized by maximizing the sections where all the voltages u1 to u3 at the AC sides of the first to third self-excited single-phase inverter circuits 3A to 3C become zero as described above.

In this embodiment with this regard, the null voltage sections δ1 to δ3 of the voltages u1 to u3 at the AC sides of the first to third self-excited single-phase inverter circuits 3A to 3C are controlled so that the arithmetic circuit 35 for the control apparatus 30 satisfies the aforementioned expression (1). Therefore, the sections where all the voltages u1 to u3 become zero can be maximized and the circulating current which occurs at the three-winding high-frequency transformer 5 can be thereby minimized.

### (3) Advantageous Effects of this Embodiment

If the control system for the three-terminal static DC transformer 1 according to this embodiment as described above is employed, it is possible to suppress the peak values and the root mean square values of the electric currents iL1 to iL3 at the AC sides of the first to third self-excited single-phase inverter circuits 3A to 3C, which constitute the three static DC transformer 1, and minimize the circulating current which circulates between the AC sides and does not contribute to the electric power transmission. Therefore, if the control system for this three-terminal static DC transformer 1 is employed, it is possible to effectively prevent the safety impairment and the degradation of the conversion efficiency even when the voltage difference between the DC terminals is large.

### (4) Other Embodiments

Incidentally, the aforementioned embodiment has described the case where the control apparatus 30 is configured as illustrated in FIG. 2; however, without limitation to this example, the present invention can apply a wide variety of other configurations.

Moreover, the aforementioned embodiment has described the case where the control apparatus 30 is configured as illustrated in FIG. 2; however, without limitation to this example, the present invention can apply a wide variety of other configurations.

### INDUSTRIAL AVAILABILITY

The present invention can be applied to a wide variety of control apparatuses for drive-controlling the three-terminal static DC transformer with a large electric potential difference between the respective DC terminals.

### REFERENCE SIGNS LIST

1: three static DC transformer
2, 2A to 2C: DC terminal(s)
3, 3A to 3C: self-excited single-phase inverter circuit(s)
4, 4A to 4C: DC capacitor(s)
5: three-winding high-frequency transformer
10 to 13, 10A to 13A, 10B to 13B, 10C to 13C: self-arc-extinguishing elements
18 iron core
14 to 17, 14A to 17A, 14B to 17B, 14C to 17C: diodes
19A to 19C: windings
20A to 20C: external inductors
30: control apparatus
31 to 33: detectors
34: minimum voltage terminal detection circuit
35 arithmetic circuit
iL1 to iL3: electric currents
Leg1, Leg2: self-arc-extinguishing element pairs
PL1 to PL4, PL1A to PL4A, PL1B to PL4B, PL1C to PL4C: ignition pulses
u1, u2, u3: voltages
V1 to V3: voltages
ϕ1 to ϕ3, φ2, φ3: phase differences
δ1 to δ3: null voltage sections

1. A control apparatus for a three-terminal static DC transformer for drive-controlling the three-terminal static DC transformer configured so that first, second, and third self-excited single-phase inverters which are connected parallelly to DC capacitors, respectively, at their DC sides are connected via a high frequency transformer at their AC sides so as to supply electric power between first, second, and third DC terminals to which the first, second, and third self-excited single-phase inverters corresponding to the first, second, and third DC terminals, respectively, are connected,
the control apparatus comprising a computing unit that drives each of the first, second, and third self-excited single-phase inverters so that voltages at the AC side are respectively caused to undergo time changes cyclically in three levels, that is, a positive voltage, a null voltage, and a negative voltage, and time when sections of the null voltage regarding the voltages at the AC sides of the first, second, and third self-excited single-phase inverters overlap in time with each other is maximized.

2. The control apparatus for the three-terminal static DC transformer according to claim 1, wherein the computing unit drives each of the first, second, and third self-excited single-phase inverters to satisfy a mathematical expression below:
$$\begin{matrix}[ Math . 2 ] & \\ ( π - δ 1 ) V 1 = ( π - δ 2 ) V 2 = ( π - δ 3 ) V 3 & ( 2 )\end{matrix}$$
where V1 represents a voltage of the first DC terminal connected to the first self-excited single-phase inverter; V2 represents a voltage of the second DC terminal connected to the second self-excited single-phase inverter; V3 represents a voltage of the third DC terminal connected to the third self-excited single-phase inverter; δ1 represents time of the null voltage which is the voltage of the AC side of the first self-excited single-phase inverter; δ2 represents time of the null voltage which is the voltage at the AC side of the second self-excited single-phase inverter; and δ3 represents time of the null voltage which is the voltage at the AC side of the third self-excited single-phase inverter.

3. The control apparatus for the three-terminal static DC transformer according to claim 2, wherein the first, second, and third self-excited single-phase inverters include first, second, third, and fourth self-arc-extinguishing elements which configure a bridge circuit;
a first self-arc-extinguishing element pair which consists of the first and second self-arc-extinguishing elements and a second self-arc-extinguishing element pair which consist of the third and fourth self-arc-extinguishing elements are connected parallelly between the first, second, or third DC terminal which corresponds to them; and
the computing unit controls the time of the null voltage which is the voltages at the AC side of the first, second, and third self-excited single-phase inverters by controlling a phase difference, regarding the first, second, and third self-excited single-phase inverters, between an ignition pulse to be applied to each of the first and second self-arc-extinguishing elements which constitute the first self-arc-extinguishing element pair, and an ignition pulse to be applied to each of the third and fourth self-arc-extinguishing elements which constitute the second self-arc-extinguishing element pair.
